(19) United States
(12) Patent Application Publication
(10) Pub. No.: US 2026/0008923 A1
(43) Pub. Date: Jan. 8, 2026

(54) METHOD FOR PRODUCING COMPOSITE TALC POWDER MATERIAL AND HOUSING THEREOF

(71) Applicant: ASUSTEK COMPUTER INC., TAIPEI (TW)

(72) Inventors: Fei-Lin YANG, TAIPEI (TW); Kuan-Hsuan CHIANG, TAIPEI (TW)

(21) Appl. No.: 18/905,444

(22) Filed: Oct. 3, 2024

(30) Foreign Application Priority Data
Jul. 2, 2024 (CN) 202410877151.9

(51) Int. Cl. C09C 1/00; C08K 3/26; C08K 3/34; C09C 3/04

(52) U.S. Cl. CPC C09C 1/0009; C08K 3/26; C08K 3/34; C09C 3/041; C09C 3/043; C01P 2004/61; C08K 2003/265; C08K 2003/343; C08K 2201/014

(57) ABSTRACT

Disclosed are a method for producing a composite talc powder material and a housing thereof. The method for producing a composite talc powder material includes the following steps. firstly, evenly mixing a talc powder material, a bio-powder material and a solvent to produce a mixed solution; subsequently, filtering the mixed solution to obtain a mixed powder material; then drying the mixed powder material to obtain a dry powder material; next sintering the dry powder material to produce a sinter cake material; and then pulverizing and grinding the sinter cake material to obtain the composite talc powder material. Besides, the disclosure provides a housing manufactured by using the composite talc powder material.

### CROSS-REFERENCE TO RELATED APPLICATION

This application claims the priority benefit of Chinese application serial No. 202410877151.9, filed on Jul. 2, 2024. The entirety of the above-mentioned patent application is hereby incorporated by reference herein and made a part of the specification.

### BACKGROUND OF THE INVENTION

### Field of the Invention

The disclosure relates to a method for producing a powder material and particularly relates to a method for producing a composite talc powder material and a housing manufactured by using the composite talc powder material.

### Description of the Related Art

The application of talcum powder is wide. For electronic products, the talcum powder can be used as a mark for welding or metal processing and can be mixed into a housing of an electronic product to endow whiteness and improve the strength of the housing.

However, conventional talc powder comes from the stratum. In the process of mineral mining and processing, environmental burden and resource waste are easily caused. How to reduce the impact on the environment and meet the industrial requirements at the same time is a subject to be solved urgently in the field.

### BRIEF SUMMARY OF THE INVENTION

The disclosure provides a method for producing a composite talc powder material. The method for producing a composite talc powder material includes the following steps: firstly, evenly mixing a talc powder material, a bio-powder material and a solvent to produce a mixed solution; subsequently, filtering the mixed solution to obtain a mixed powder material; then drying the mixed powder material to obtain a dry powder material; next sintering the dry powder material to produce a sinter cake material; and then pulverizing and grinding the sinter cake material to obtain the composite talc powder material.

Besides, the disclosure provides a housing suitable for an electronic device. The housing is manufactured by using a plastic material and the composite talc powder material.

The composite talc powder material can effectively reduce the use amount of talc powder and reduce the impact of mineral mining on the environment. In addition, the bio-powder material matched in the composite talc powder material is a recycled material, is also beneficial to reducing carbon emission and meets the goal of sustainable development.

### BRIEF DESCRIPTION OF THE DRAWINGS

FIG. 1 is a flow diagram of the method for producing a composite talc powder material according to an example of the disclosure;

FIG. 2 shows an example of step S110 in FIG. 1; and

FIG. 3 shows an example of step S140 in FIG. 1.

### DETAILED DESCRIPTION OF THE EMBODIMENTS

The specific embodiments of the disclosure are described in detail below with reference to the accompanying drawings. According to the following description and the scope of the patent application, the advantages and features of the disclosure will be clearer. It should be noted that the drawings all adopt very simplified forms and all use imprecise ratios, which are only used for the purpose of conveniently and clearly assisting in describing the examples of the disclosure.

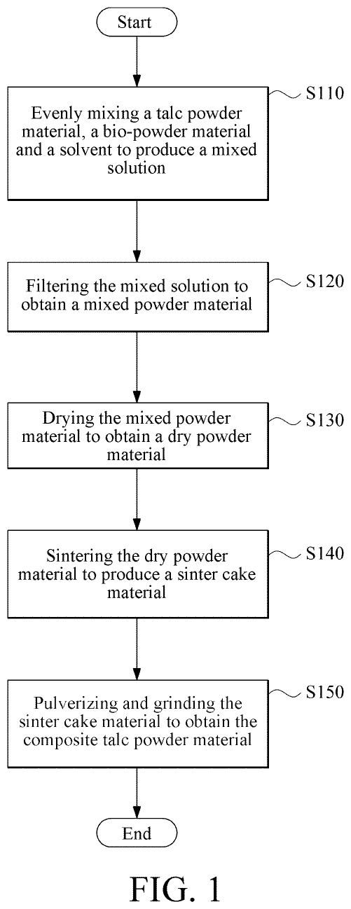

FIG. 1 is a flow diagram of the method for producing a composite talc powder material according to an example of the disclosure.

The disclosure provides a method for producing a composite talc powder material. The method for producing a composite talc powder material includes the following steps.

Firstly, as described in step S110, a talc powder material, a bio-powder material and a solvent are evenly mixed to produce a mixed solution.

In an example, the talc powder material may be an industrial-grade talc powder containing a hydrous magnesium silicate (MgxSiyOz(OH)2) powder with the purity of 99% or more. The particle size of the talc powder material is between 3 μm and 10 μm.

In an example, the bio-powder material is a recycled oyster shell powder material that has been refined and contains a calcium carbonate (CaCO3) powder with the purity of 99.3%. The particle size of the bio-powder material (such as the oyster shell powder material) is between 3 μm and 10 μm. The particle size of the talc powder material used in the disclosure is close to that of the bio-powder material so as to ensure the quality of the finally produced composite talc powder material.

In addition, it should be noted that in order to meet the goals of environmental protection and sustainable development, in addition to using the oyster shell powder material, the disclosure also uses powder produced by other mollusc shells or animal skeletons.

In an example, the solvent used in step S110 is polysorbate, benzyl alcohol, etc. which dissolves calcium, magnesium, etc. so as to ensure that the talc powder material is evenly mixed with the bio-powder material.

In addition, in terms of the use ratio of the bio-powder material to the talc powder material, although reducing the use amount of the talc powder material is helpful for meeting the environmental protection requirement, too low ratio of the talc powder material ratio results in poor quality of the finally produced composite talc powder material. In an example, the ratio of the talc powder material to the bio-powder material should be maintained above 1:1, i.e. the weight of the talc powder material is greater than or equal to that of the bio-powder material so as to maintain the desired material properties.

Subsequently, as described in step S120, the mixed solution is filtered to obtain a mixed powder material. Then, as described in step S130, the mixed powder material is dried to obtain a dry powder material. Next, as described in step S140, the dry powder material is sintered to produce a sinter cake material.

Subsequently, as described in step S150, the sinter cake material is pulverized and ground to obtain a composite talc powder material. In an example, the particle size of the composite talc powder material produced in step S150 is between 3 μm and 10 μm.

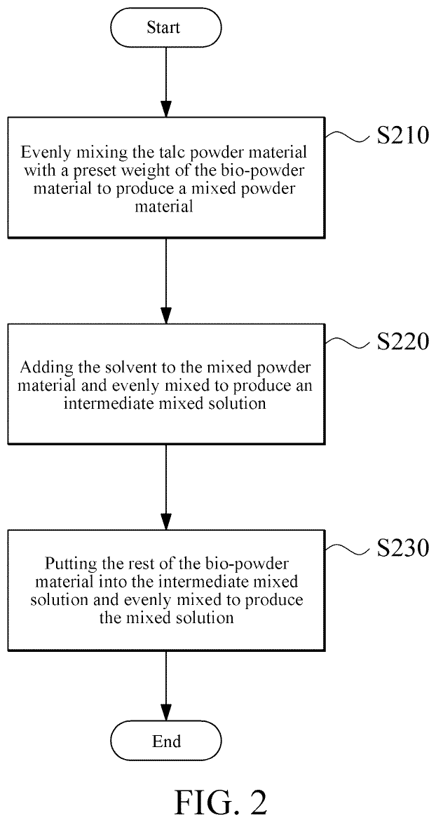

FIG. 2 is referred and shows an example of step S110 in FIG. 1.

Firstly, as described in step S210, the talc powder material is evenly mixed with a preset weight of the bio-powder material to produce a mixed powder material.

Subsequently, as described in step S220, the solvent is added to the mixed powder material and evenly mixed to produce an intermediate mixed solution.

Next, as described in step S230, the rest of the bio-powder material is put into the intermediate mixed solution and evenly mixed to produce the mixed solution.

For example, if the ratio of the talc powder material to the bio-powder material is 9:3, in step S210, 9 parts of the talc powder material and 1 part of the bio-powder material is firstly evenly mixed to produce a mixed powder material. The rest 2 parts of the bio-powder material are put into the intermediate mixed solution and evenly mixed to produce a mixed solution in step S230.

In an example, if the ratio of the talc powder material to the bio-powder material is very different, for example, the ratio of the bio-powder material is less than or equal to 10% of all the powder materials, the talc powder material is directly mixed with all the bio-powder material and then the solvent is added to be evenly mixed to produce a mixed solution.

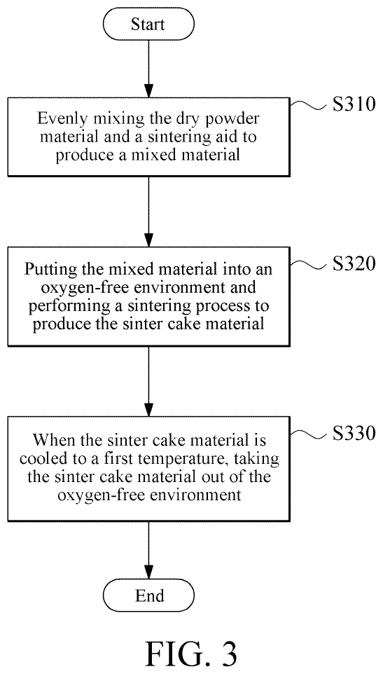

FIG. 3 is referred and shows an example of step S140 in FIG. 1.

Firstly, as described in step S310, the dry powder material and a sintering aid are evenly mixed to produce a mixed material. The sintering aid uses magnesium oxide (MgO) as a main material. In an example, the step is performed by putting the dry powder material and the sintering aid into a V-shaped mixing barrel for mixing.

Subsequently, as described in step S320, the mixed material is put into an oxygen-free environment and a sintering process is performed to produce the sinter cake material.

Then, as described in step S330, when the sinter cake material is cooled to a first temperature, the sinter cake material is taken out of the oxygen-free environment.

In an example, a sintering temperature used in the sintering process as described in step S320 is between 1,100° C. and 1,300° C., and the duration of the sintering process is 1-3 hours. In an example, the first temperature in step S330 is higher than room temperature but lower than 500° C. In an example, the oxygen-free environment is a nitrogen environment.

Besides, the disclosure provides a housing suitable for an electronic device. The housing is manufactured by using a plastic material and the composite talc powder material produced by the method for producing the composite talc powder material. In an embodiment, the plastic material is polycarbonate (PC), ABS resin or other plastic materials suitable for use as structural members.

Table I shows the material properties of the composite talc powder material produced by different formulas. The talc powder material in the table is an industrial-grade talc powder containing hydrous magnesium silicate (MgxSiyOz(OH)2) powder with the purity of 99% or more. The particle size of the talc powder material is between 3 μm and 10 μm. The bio-powder material in the table is a recycled oyster shell powder material that has been refined and contains a calcium carbonate (CaCO3) powder with the purity of 99.3%. The particle size of the oyster shell powder material is between 3 μm and 10 μm

The ratio of the oyster shell powder material and the talc powder material in each formula refers to the weight percentages of the oyster shell powder material and the talc powder material in the powder material prepared by the formula. The sintering aid ratio in the table refers to the weight percentage of the sintering aid relative to the dry powder material. The tensile strength in the table is the tensile strength of a composite material produced by adding 15 wt % of the composite talc powder material to the plastic material such as polycarbonate (PC) or ABS resin. The loss on ignition in the table refers to the actual weight after water is subtracted.

TABLE I

| Formula | I | II | III |
|---|---|---|---|
| Oyster shell powder material | 10% | 20% | 30% |
| Talc powder material | 90% | 80% | 70% |
| Sintering aid | 1.3% | 1.3% | 1.3% |
| Sulfur content | 0.0003% | 0.0004% | 0.0004% |
| Loss on ignition | 99.1% | 98.7% | 97.7% |
| Tensile strength | 750 MPa | 725 MPa | 701 MPa |

As shown in the table, the tensile strength is less than 100 MPa compared to that of general polycarbonate (PC) or ABS resin materials. The composite talc powder material is added into the plastic material to manufacture the housing of the electronic device in the disclosure so as to effectively improve the overall strength and hardness of the housing.

In conclusion, the composite talc powder material provided by the disclosure can effectively reduce the use amount of talc powder and reduce the impact of mineral mining on the environment. In addition, the bio-powder material matched in the composite talc powder material is a recycled material. The used bio-powder material is also beneficial to reducing carbon emission and meets the goal of sustainable development.

The above are merely preferred examples of the disclosure, which do not impose any limitation on the disclosure. Any form of equivalent replacement or modification and the like performed on the technical means and technical contents disclosed by the disclosure by those skilled in the art without departing from the technical means of the disclosure do not deviate from the technical means of the disclosure and still fall within the protection scope of the disclosure.

What is claimed is:

1. A method for producing a composite talc powder material, comprising:
evenly mixing a talc powder material, a bio-powder material and a solvent to produce a mixed solution;
filtering the mixed solution to obtain a mixed powder material;
drying the mixed powder material to obtain a dry powder material;
sintering the dry powder material to produce a sinter cake material; and
pulverizing and grinding the sinter cake material to obtain the composite talc powder material.

2. The method according to claim 1, wherein the bio-powder material is an oyster shell powder material.

3. The method according to claim 2, wherein the particle size of the oyster shell powder material is between 3 μm and 10 μm.

4. The method according to claim 2, wherein the particle size of the talc powder material is between 3 μm and 10 μm.

5. The method according to claim 2, wherein the weight of the talc powder material is greater than or equal to that of the bio-powder material.

6. The method according to claim 1, wherein the step of evenly mixing the talc powder material, the bio-powder material and the solvent to produce the mixed solution comprises:
evenly mixing the talc powder material with a preset weight of the bio-powder material to produce a mixed powder material;
adding the solvent to the mixed powder material and mixing evenly to produce an intermediate mixed solution; and
putting the rest of the bio-powder material into the intermediate mixed solution and mixing evenlyed to produce the mixed solution.

7. The method according to claim 1, wherein the step of sintering the dry powder material to produce the sinter cake material comprises:
evenly mixing the dry powder material and a sintering aid to produce a mixed material;
putting the mixed material into an oxygen-free environment and performing a sintering process to produce the sinter cake material; and
when the sinter cake material is cooled to a first temperature, taking the sinter cake material out of the oxygen-free environment.

8. The method according to claim 7, wherein a sintering temperature used in the sintering process is between 1,100° C. and 1,300° C., and the duration of the sintering process is 1-3 hours.

9. The method according to claim 7, wherein the first temperature is lower than 500° C.

10. The method according to claim 7, wherein the oxygen-free environment is a nitrogen environment.

11. The method according to claim 1, wherein the particle size of the composite talc powder material is between 3 μm and 10 μm.

12. A housing suitable for an electronic device, wherein the housing is manufactured by using a plastic material and the composite talc powder material produced by the method of claim 1.
